(19) United States
(12) Patent Application Publication
(10) Pub. No.: US 2025/0230682 A1
(43) Pub. Date: Jul. 17, 2025

(54) Tamper-Resistant Locking System and Method

(71) Applicant: Willo Products Company, LLC, Decatur, AL (US)

(72) Inventors: Stephen Brian Foss, Madison, AL (US); Brian Keith Terry, Locust Fork, AL (US); Arren Jacob Matthews, Decatur, AL (US)

(21) Appl. No.: 19/014,405

(22) Filed: Jan. 9, 2025

Related U.S. Application Data
(60) Provisional application No. 63/619,868, filed on Jan. 11, 2024.
(60) Provisional application No. 63/687,411, filed on Aug. 27, 2024.

(51) Int. Cl. E05B 17/00; E05B 9/00; E05B 9/02; E05B 65/00

(52) U.S. Cl. CPC E05B 17/0004; E05B 9/02; E05B 65/0017; E05B 2009/004

(57) ABSTRACT

A lock system includes first, second, and third covers. The first cover includes a first wall, a second wall, a first latch feature, and a second feature. The first wall extends in a first direction. The second wall is coupled to the first wall and extends in a second direction transverse to the first direction. The second cover extends in a third direction and includes a third latch feature configured to receive the first latch feature. The third cover extends in a fourth direction and includes a fourth latch feature configured to receive the second latch feature.

### CROSS-REFERENCE TO RELATED APPLICATIONS

This application claims the benefit of U.S. Provisional Application No. 63/619,868 filed Jan. 11, 2024. This application also claims the benefit of U.S. Provisional Application No. 63/687,411 filed Aug. 27, 2024. The entire disclosures of the above applications are incorporated by reference.

### FIELD

This disclosure relates generally to a tamper-resistant locking system and method for a door, and more particularly to a lockable cover for a tamper-resistant locking system and method.

### BACKGROUND

This section provides background information related to the present disclosure and is not necessarily prior art.

Door locking systems are essential components for securing doors at prisons and various other properties and facilities. These systems are typically attached to the exterior side of a door, allowing authorized individuals to access a room (e.g., a prison cell) on the interior side of the door, and preventing unauthorized individuals from opening the door and exiting the room on the interior side of the door. The security of these door locking systems can be compromised if the housing enclosing the locking system is susceptible to tampering or forced entry. For example, tampering with the housing that encloses the door locking systems, or components thereof, can leave the lock mechanism or other components within the door locking system vulnerable to manipulation or vandalism, which can create a security risk in situations where the components within the door locking system are crucial for opening the door.

While known systems and methods for securing door locking systems may be acceptable for their intended purposes, there exists a continuous need in the pertinent art for an improved system and method for inhibiting tampering with a door locking system.

### SUMMARY

This section provides a general summary of the disclosure, and is not a comprehensive disclosure of its full scope or all of its features.

One aspect of the disclosure provides a lock system. The lock system includes first, second, and third covers. The first cover includes a first wall, a second wall, a first latch feature, and a second feature. The first wall extends in a first direction. The second wall is coupled to the first wall and extends in a second direction transverse to the first direction. The second cover extends in a third direction and includes a third latch feature configured to receive the first latch feature. The third cover extends in a fourth direction and includes a fourth latch feature configured to receive the second latch feature.

Another aspect of the disclosure provides a lock system. The lock system includes first and second covers. The first cover includes a first wall and a first latch feature. The first wall extends in a first direction. The first latch feature includes a first arm and a second arm. The first arm extends from the first wall in a second direction transverse to the first direction. The second arm includes a first end and a second end opposite the first end. The first arm connects to the second arm at a point between the first end and the second end. The second cover includes a second wall and a second latch feature the second wall extends in a fourth direction. The second latch feature is configured to receive the first latch feature.

Another aspect of the disclosure provides a lock system. The lock system includes first and second covers. The first cover includes a first wall and a first latch feature. The first wall extends in a first direction. The first latch feature includes a first arm and a second arm. The first arm extends from the first wall in a second direction transverse to the first direction. The second arm extends from an end of the first arm in a third direction transverse to the second direction. The second cover includes a second wall and a second latch feature the second wall extends in a fourth direction. The second latch feature is configured to receive the first latch feature.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and not all possible implementations, and are not intended to limit the scope of the present disclosure.

FIG. 1 is a perspective view of a door locking system in an open orientation according to the principles of the present disclosure.

FIG. 2 is a perspective view of the door locking system of FIG. 1 in a closed orientation according to the principles of the present disclosure.

FIG. 3A is a plan view of a first cover member of the system of FIG. 1 in a first pre-assembled configuration according to the principles of the present disclosure.

FIG. 3B is a plan view of the first cover member of FIG. 3A in a second pre-assembled configuration according to the principles of the present disclosure.

FIG. 3C is a plan view of another first cover member of the system of FIG. 1 in a first pre-assembled configuration according to the principles of the present disclosure.

FIG. 3D is a plan view of the first cover member of FIG. 3C in a second pre-assembled configuration according to the principles of the present disclosure.

FIG. 3E is a plan view of another first cover member of the system of FIG. 1 in a first pre-assembled configuration according to the principles of the present disclosure.

FIG. 3F is a plan view of the first cover member of FIG. 3E in a second pre-assembled configuration according to the principles of the present disclosure.

FIG. 4A is a plan view of a second cover member of the system of FIG. 1 in a first pre-assembled configuration according to the principles of the present disclosure.

FIG. 4B is a plan view of the second cover member of FIG. 4A in a second pre-assembled configuration according to the principles of the present disclosure.

FIG. 4C is a plan view of another second cover member of the system of FIG. 1 in a first pre-assembled configuration according to the principles of the present disclosure.

FIG. 5A is a plan view of a third cover member of the system of FIG. 1 in a first pre-assembled configuration according to the principles of the present disclosure.

FIG. 5B is a plan view of the third cover member of FIG. 5A in a second pre-assembled configuration according to the principles of the present disclosure.

FIG. 6A is a plan view of a base plate of the system of FIG. 1 in a first pre-assembled configuration according to the principles of the present disclosure.

FIG. 6B is a first perspective view of the base plate of FIG. 6A in a second configuration according to the principles of the present disclosure.

FIG. 6C is a second perspective view of the base plate of FIG. 6A in the second configuration according to the principles of the present disclosure.

FIG. 6D is a plan view of the base plate of FIG. 6A in a third pre-assembled configuration according to the principles of the present disclosure.

FIG. 7A is a perspective view of a cover lockdown subassembly in a pre-assembled configuration according to the principles of the present disclosure.

FIG. 7B is a perspective view of the cover lockdown subassembly of FIG. 7A in a pre-assembled configuration according to the principles of the present disclosure.

FIG. 7C is a cross-sectional view of the cover lockdown subassembly of FIG. 7A in an assembled configuration according to the principles of the present disclosure.

FIG. 8 is a cross-sectional view of the system of FIG. 1 taken through the line A-A according to the principles of the present disclosure.

FIG. 9 is a cross-sectional view of the system of FIG. 1 taken through the line B-B according to the principles of the present disclosure.

FIG. 10 is a cross-sectional view of the system of FIG. 1 taken through the line C-C according to the principles of the present disclosure.

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

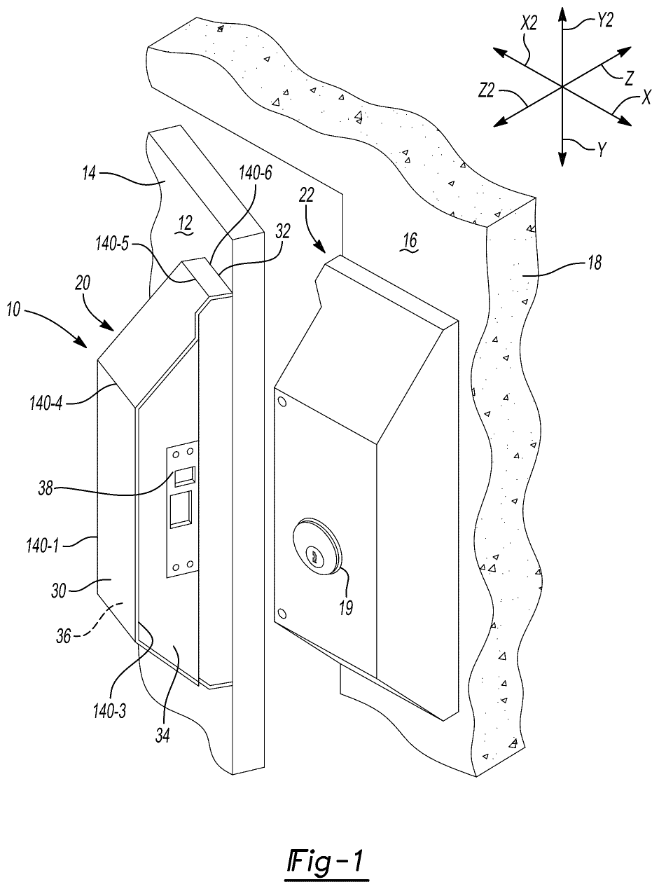

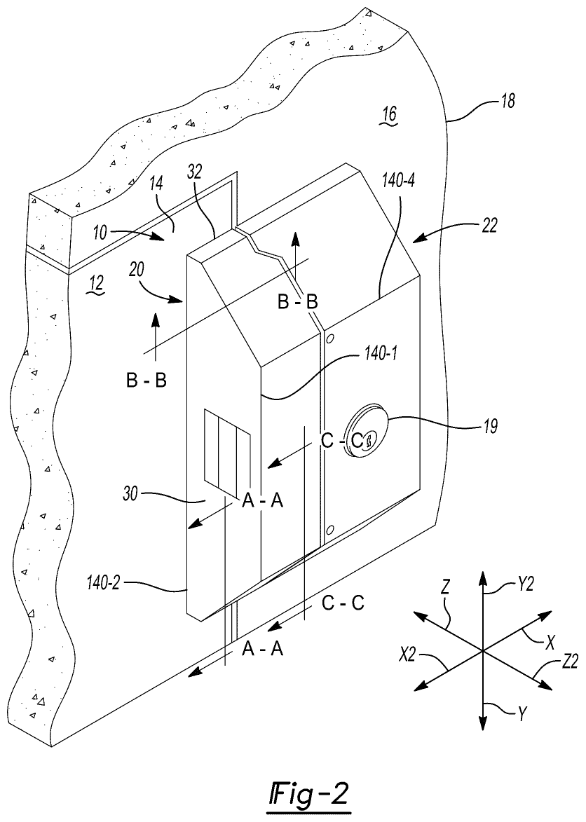

Referring to FIGS. 1-2, a lock system 10 is illustrated. As will be explained in more detail below, the lock system 10 may be mounted on an exterior surface 12 of a door 14 and an exterior surface 16 of a wall 18 to secure the door 14 in a closed orientation (e.g., FIG. 2) relative to the wall 18. In this regard, the lock system 10 may include a lock mechanism 19 that secures a position of a first housing assembly 20 of the lock system 10 relative to a second housing assembly 22 of the lock system 10. While the first housing assembly 20 is generally shown and described herein as being mounted on the door 14, and the second housing assembly 22 is generally shown and described herein as being mounted on the wall 18, it will be appreciated that the first housing assembly 20 may be mounted on the wall 18, and the second housing assembly 22 may be mounted on the door 14 within the scope of the present disclosure.

The first housing assembly 20 may include a first (e.g., front) cover 30, a second (e.g., rear) cover 32, a third (e.g., side) cover 34, and a cover lockdown subassembly 35. As explained in more detail below, the first cover 30, the second cover 32, or the third cover 34 may be removably coupled to one or more of the others of the first cover 30, the second cover 32, or the third cover 34 to enclose an interior portion 36 (e.g., chamber) of the first housing assembly 20. For example, the first cover 30 may be removably coupled to the second cover 32 and the third cover 34, and the second cover 32 may be removably coupled to the third cover 34. As illustrated in FIG. 1, the third cover 34 may define one or more openings 38 that receive one or more latch features (e.g., roller bolt, lock bolt) of the second housing assembly 22 when the first and second housing assemblies 20, 22 are in the closed orientation (e.g., FIG. 2) in order to secure the first and second housing assemblies 20, 22 in the closed orientation.

### Front Cover

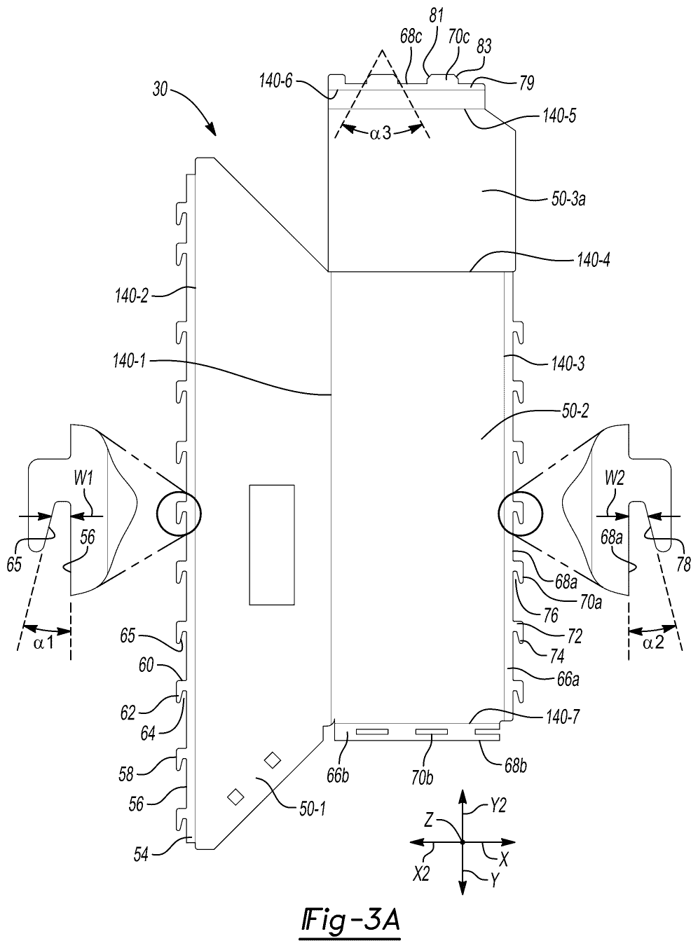

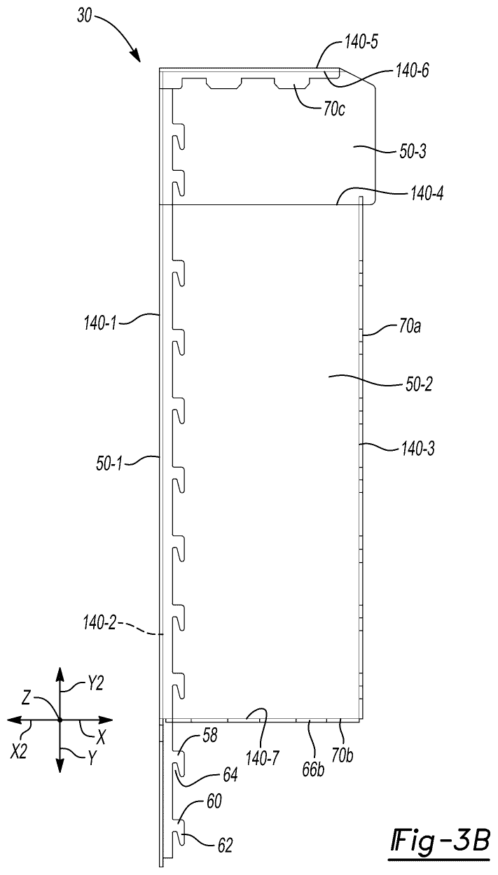

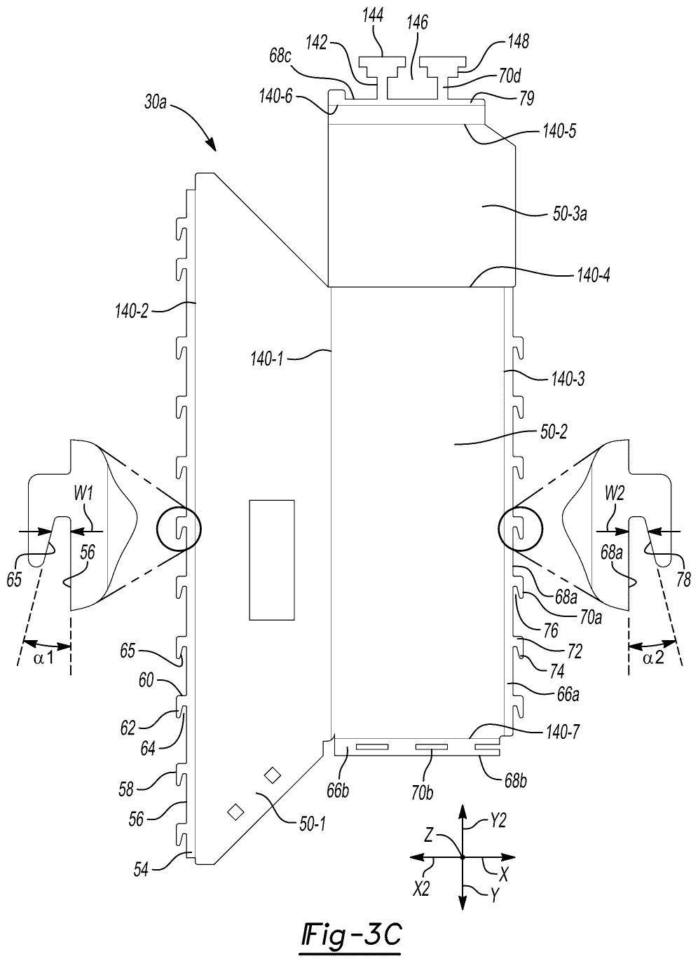

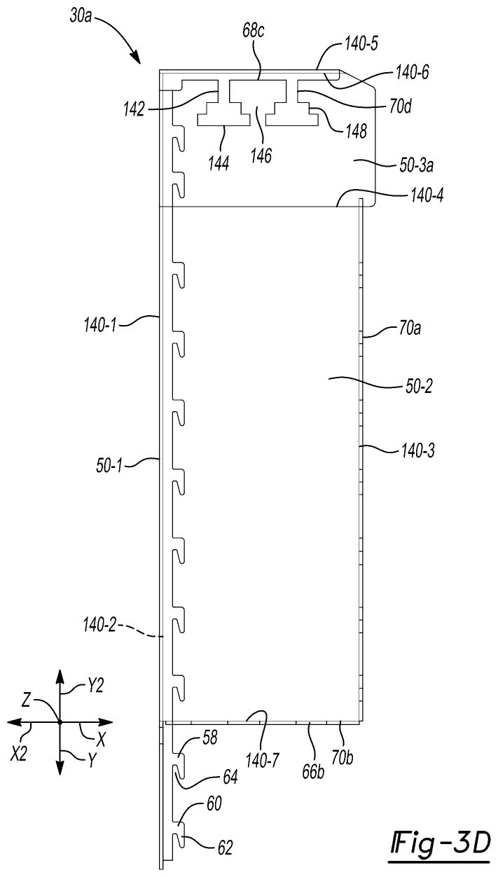

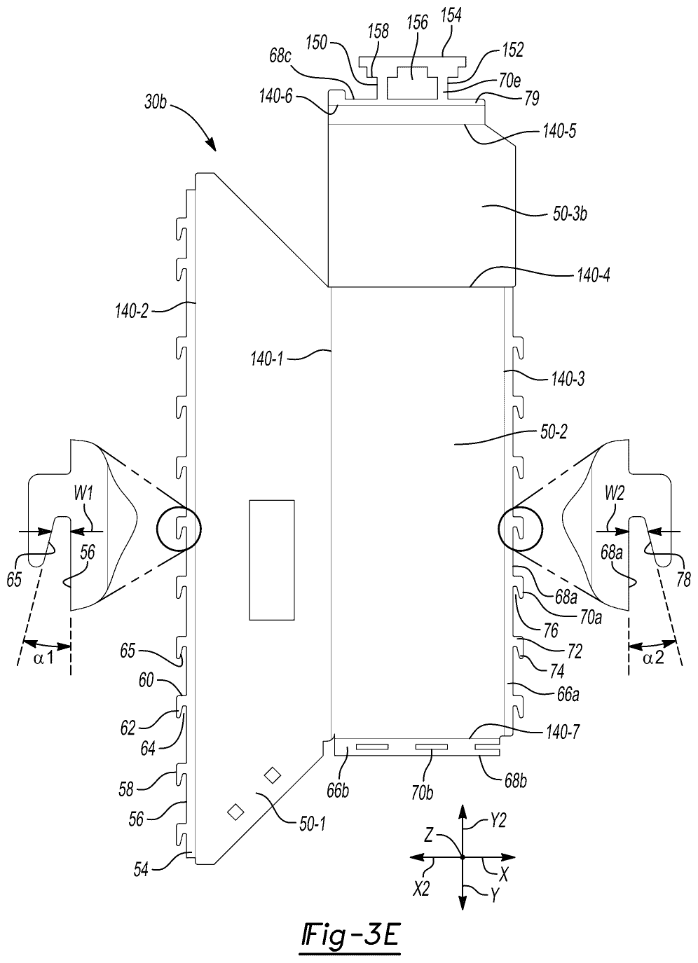

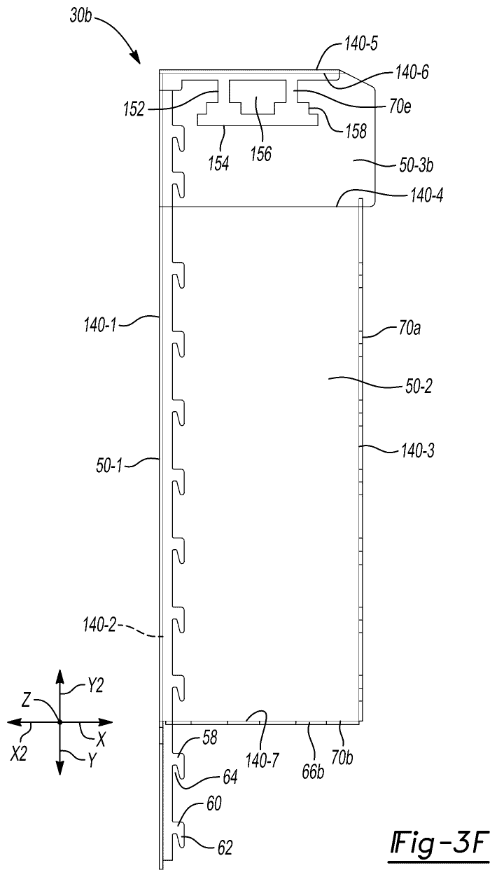

With reference to FIGS. 3A and 3B, the first cover 30 may include a plurality of walls 50. For example, the first cover 30 may include a side wall 50-1, a front wall 50-2, and an upper wall 50-3. The front wall 50-2 may be coupled to the side wall 50-1. The upper wall 50-3 may be coupled to the front wall 50-2 and/or the side wall 50-1. It will be appreciated that the first cover 30 may also include more or less than two walls 50 within the scope of the present disclosure. In some implementations, one or more of the walls 50 is integrally formed with one or more of the other walls 50. For example, the first cover 30 may be formed from a stamped metal plate such that the walls 50 define a monolithic construct having one or more folds (e.g., a bend in the piece of material) between the walls 50. It will be appreciated, however, that the first cover 30 may be formed from different materials (e.g., a polymer, carbon fiber, etc.) and by different processes (e.g., molding, three-dimensional printing, etc.) within the scope of the present disclosure.

The side wall 50-1 may include a lip 54 extending therefrom. In the bent configuration (e.g., FIGS. 1 and 2), the side wall 50-1 and the lip 54 extend in transverse (e.g., orthogonal) directions such that the side wall 50-1 and the lip 54 define an “L” shape. In this regard, the lip 54 may extend from the side wall 50-1 in a direction X in the assembled configuration. In some implementations, the lip 54 forms at least a portion of an edge 56 of the side wall 50-1.

The side wall 50-1 may also include one or more latch features 58. In some implementations, the latch features 58 include one or more tabs extending from the side wall 50-1. In this regard, the latch features 58 may be referred to herein as tabs 58. In some implementations, the latch features 58 include a first arm 60 extending from the edge 56 in the direction X, and a second arm 62 extending from the first arm 60 in a direction Y such that the first arm 60 and the second arm 62 define an “L” shape. In this regard, the second arm 62 and the edge 56 may define a void 64 therebetween. The second arm 62 may include an edge 65 facing the edge 56 of the lip 54. In some implementations, the edge 65 and the edge 56 define an angle α1 therebetween such that a width W1 of the void 64 increases in the direction Y. In this regard, the a1 may be greater than 0 degrees and less than 90 degrees. In some implementations, the angle α1 is substantially (e.g., +/−20 degrees) equal to 25 degrees. As will be explained in more detail below, during assembly of the system 10, the angle α1 may pull the side wall 50-1 towards (e.g., in the direction X) the second cover 32 as the latch feature 58 mates with a corresponding latch feature of the second cover 32 to ensure a secure connection between the first and second covers 30, 32.

The front wall 50-2 may include a first lip 66a and a second lip 66b extending therefrom. In the assembled configuration, the front wall 50-2 and the first lip 66a may extend in transverse (e.g., orthogonal) directions such that the front wall 50-2 and the first lip 66a define an “L” shape. In this regard, the first lip 66a may extend from the front wall 50-2 in a direction Z (e.g., into the page relative to the view in FIG. 3A). In some implementations, the first lip 66a forms at least a portion of an edge 68a of the front wall 50-2.

The front wall 50-2 may also include one or more latch features 70a. In some implementations, the latch features 70a include one or more tabs extending from the front wall 50-2. In some implementations, the latch features 70a include a first arm 72 extending from the edge 68a in the direction Z, and a second arm 74 extending from the first arm 72 in the direction Y such that the first arm 72 and the second arm 74 define an “L” shape. In this regard, the second arm 74 and the edge 68a may define a void 76 therebetween. The second arm 74 may include an edge 78 facing the edge 68a of the first lip 66a. In some implementations, the edge 68a and the edge 78 define an angle α2 therebetween such that a width W of the void 64 increases in the direction Y. In this regard, the a2 may be greater than 0 degrees and less than 90 degrees. In some implementations, the angle α2 is substantially (e.g., +/−20 degrees) equal to 25 degrees. As will be explained in more detail below, during assembly of the system 10, the angle α2 may pull the side wall 50-1 towards the second cover 32 as the latch feature 70a mates with a corresponding latch feature of the third cover 34 to ensure a secure connection between the first and third covers 30, 34.

In the assembled configuration, the second lip 66b and the front wall 50-2 may extend in transverse (e.g., orthogonal) directions such that the front wall 50-2 and the second lip 66b define an “L” shape. In this regard, the second lip 66b may extend from the front wall 50-2 in the direction Z. In some implementations, the second lip 66b forms at least a portion of an edge 68b of the front wall 50-2. The first edge 68a and the second edge 68b may extend in transverse (e.g., orthogonal) directions.

The second lip 66b may include one or more latch features 70b. In some implementations, the latch features 70b include one or more apertures (e.g., through-holes) formed in the second lip 66b. In this regard, the latch features 70b may be illustrated and described herein as apertures 70b.

The upper wall 50-3 may be coupled to the front wall 50-2 and may include a lip 79 extending therefrom. In the assembled configuration, the upper wall 50-3 and the lip 79 extend in transverse (e.g., orthogonal) directions such that the upper wall 50-3 and the lip 79 define an “L” shape. In this regard, the lip 79 may extend from the upper wall 50-3 in the direction Y. In some implementations, the lip 79 forms at least a portion of an edge 68c of the upper wall 50-3.

The upper wall 50-3 may also include one or more latch features 70c. In some implementations, the latch features 70c include a tab extending from the edge 68c in the direction Y. In some implementations, opposed side edges 81, 83 of the latch features 70c define an angle α3 therebetween. The a3 may be greater than 0 degrees and less than one hundred eighty degrees. In some implementations, the angle α3 is substantially (e.g., +/−20 degrees) equal to 25 degrees. As will be explained in more detail below, during assembly of the system 10, the angle α may cause the latch feature 70c to form a friction-fit with a corresponding latch feature of the second cover 32 to ensure a secure connection between the first and second covers 30, 32.

With reference to FIGS. 3C and 3D, another first cover 30a is illustrated. References to the first cover 30 throughout the disclosure are understood to apply equally to the first cover 30a, unless specifically stated otherwise.

The first cover 30a may include a plurality of walls 50. For example, the first cover 30a may include the side wall 50-1, the front wall 50-2, and an upper wall 50-3a. The front wall 50-2 may be coupled to the side wall 50-1. The upper wall 50-3a may be coupled to the front wall 50-2 and/or the side wall 50-1. It will be appreciated that the first cover 30a may also include more or less than two walls 50 within the scope of the present disclosure. In some implementations, one or more of the walls 50 is integrally formed with one or more of the other walls 50. For example, the first cover 30a may be formed from a stamped metal plate such that the walls 50 define a monolithic construct having one or more folds (e.g., a bend in the piece of material) between the walls 50. It will be appreciated, however, that the first cover 30a may be formed from different materials (e.g., a polymer, carbon fiber, etc.) and by different processes (e.g., molding, three-dimensional printing, etc.) within the scope of the present disclosure.

The upper wall 50-3a may be coupled to the front wall 50-2 and may include a lip 79 extending therefrom. In the assembled configuration, the upper wall 50-3a and the lip 79 extend in transverse (e.g., orthogonal) directions such that the upper wall 50-3a and the lip 79 define an “L” shape. In this regard, the lip 79 may extend from the upper wall 50-3a in the direction Y. In some implementations, the lip 79 forms at least a portion of the edge 68c of the upper wall 50-3a.

The upper wall 50-3a may also include one or more latch features 70d. In some implementations, the latch features 70d include one or more tabs extending from the edge 68c of the upper wall 50-3a in the direction Y. In some implementations, the latch features 70d include a first arm 142 extending from the edge 68c in the direction Y and a second arm 144 extending from the first arm 142 in the directions X, X2 such that the first arm 142 and the second arm 144 define a “T” shape. For example, the first arm 142 may be substantially orthogonal (e.g., 90 degrees+/−10 degrees) to the second arm 144.

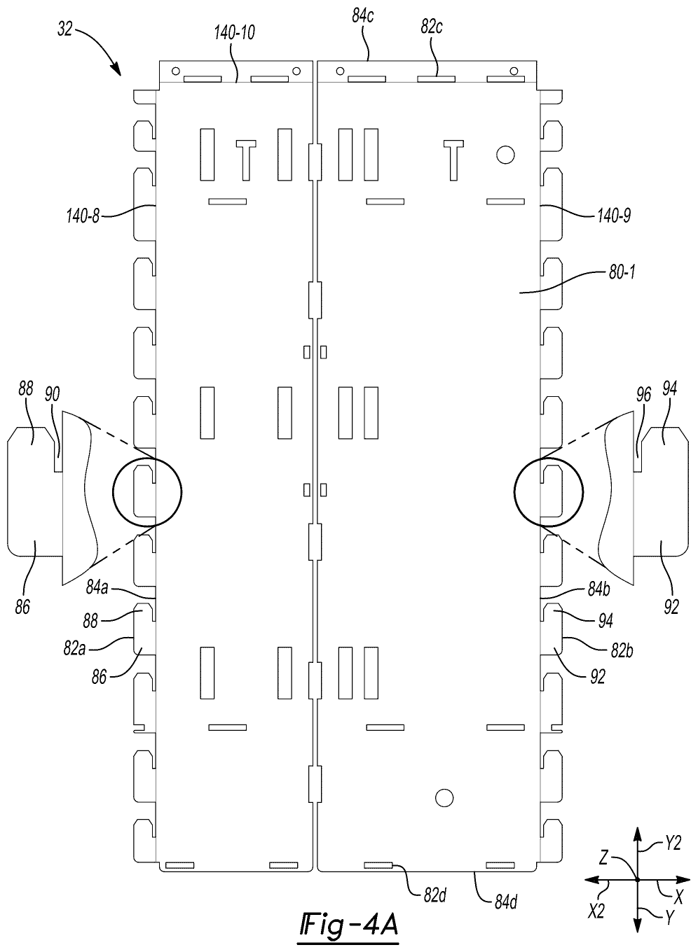

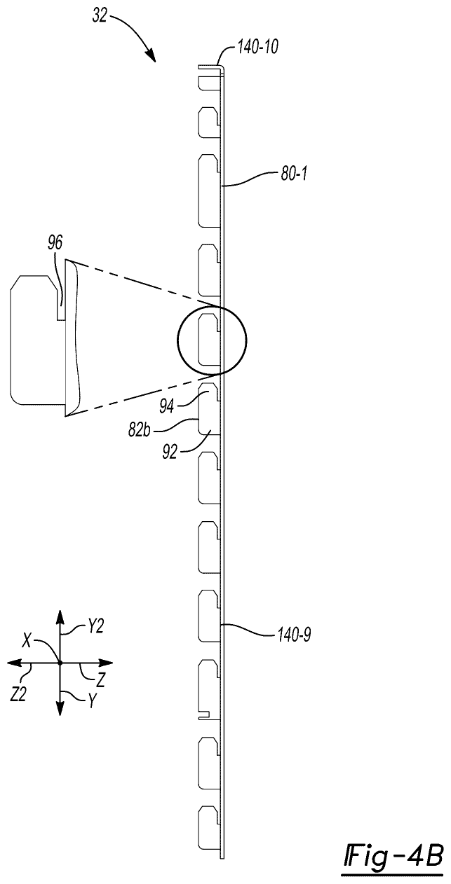

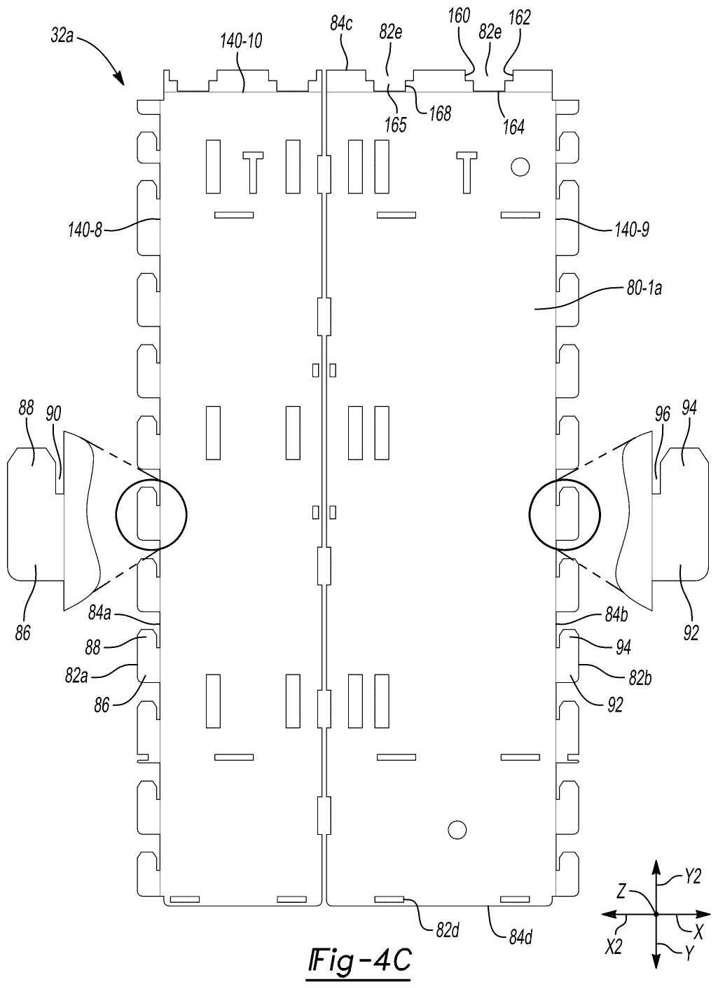

The second arm 144 and the edge 68c may define one or more voids 146 therebetween. The connection between the first arm 142 and the second arm 144 may be stepped or tapered. For example, in some implementations, the latch features 70d include one or more steps 148 where the first arm 142 connects to the second arm 144. The steps 148 may form a protrusion (e.g., a square protrusion) extending from the first and second arms 142, 144. As will be explained in more detail below, during assembly of the system 10, the latch feature 70d may interface with a corresponding latch feature of a second cover 32a (FIG. 4C) to ensure a secure connection between the first and second covers 30a, 32a. For example, the latch feature 70d and the corresponding latch feature of the second cover 32a may prevent the first cover 30a from being separated from the second cover 32a by more than a quarter of an inch (0.25″).

With reference to FIGS. 3E and 3F, another first cover 30b is illustrated. References to the first cover 30 throughout the disclosure are understood to apply equally to the first cover 30b, unless specifically stated otherwise.

The first cover 30b may include a plurality of walls 50. For example, the first cover 30b may include the side wall 50-1, the front wall 50-2, and an upper wall 50-3b. The front wall 50-2 may be coupled to the side wall 50-1. The upper wall 50-3b may be coupled to the front wall 50-2 and/or the side wall 50-1. It will be appreciated that the first cover 30b may also include more or less than two walls 50 within the scope of the present disclosure. In some implementations, one or more of the walls 50 is integrally formed with one or more of the other walls 50. For example, the first cover 30b may be formed from a stamped metal plate such that the walls 50 define a monolithic construct having one or more folds (e.g., a bend in the piece of material) between the walls 50. It will be appreciated, however, that the first cover 30b may be formed from different materials (e.g., a polymer, carbon fiber, etc.) and by different processes (e.g., molding, three-dimensional printing, etc.) within the scope of the present disclosure.

The upper wall 50-3b may be coupled to the front wall 50-2 and may include a lip 79 extending therefrom. In the assembled configuration, the upper wall 50-3b and the lip 79 extend in transverse (e.g., orthogonal) directions such that the upper wall 50-3b and the lip 79 define an “L” shape. In this regard, the lip 79 may extend from the upper wall 50-3b in the direction Y. In some implementations, the lip 79 forms at least a portion of the edge 68c of the upper wall 50-3b.

The upper wall 50-3b may also include one or more latch features 70e. In some implementations, the latch feature 70e includes a tab extending from the edge 68c of the upper wall 50-3a in the direction Y. In some implementations, the latch feature 70e includes a first arm 150 and a second arm 152 extending from the edge 68c in the direction Y and a third arm 154 extending from the first arm 150 and the second arm 152 in the directions X, X2 such that the first arm 150 and the third arm 154 define a “T” shape and the second arm 152 and the third arm 154 define a “T” shape. For example, the first arm 150 may be substantially parallel to the second arm 152. The first arm 150 may be substantially orthogonal (e.g., 90 degrees+/−10 degrees) to the third arm 154. The second arm 152 may be substantially orthogonal (e.g., 90 degrees+/−10 degrees) to the third arm 154.

The third arm 154 and the edge 68c may define one or more voids 156 therebetween. The connection between (i) the first arm 150 and the third arm 154 and (ii) the second arm 152 and the third arm 154 may be stepped or tapered. For example, in some implementations, the latch feature 70e includes one or more steps 158 where the first arm 150 connects to the third arm 154 and where the second arm 152 connects to the third arm 154. The steps 158 may form a protrusion (e.g., a square protrusion) extending from one or more of the first, second, and third arms 150, 152, 154. As will be explained in more detail below, during assembly of the system 10, the latch feature 70e may interface with a corresponding latch feature of the second cover 32a to ensure a secure connection between the first and second covers 30b, 32a. For example, the latch feature 70e and the corresponding latch feature of the second cover 32a may prevent the first cover 30b from being separated from the second cover 32a by more than a quarter of an inch (0.25″).

### Rear Cover

With reference to FIGS. 4A and 4B, the second cover 32 may include one or more walls 80. For example, the second cover 32 may include a rear wall 80-1. It will be appreciated that the second cover 32 may include more than one wall 80 within the scope of the present disclosure. In some implementations, the second cover 32 is formed from a stamped metal plate such that the wall(s) 80 define a monolithic construct. It will be appreciated, however, that the second cover 32 may be formed from different materials (e.g., a polymer, carbon fiber, etc.) and by different processes (e.g., molding, three-dimensional printing, etc.) within the scope of the present disclosure.

The rear wall 80-1 may include one or more latch features 82. In some implementations, the latch features 82 include one or more tabs 82a extending from a first edge 84a of the rear wall 80-1, one or more tabs 82b extending from a second edge 84b of the rear wall 80-1, one or more apertures formed proximate to a third edge 84c of the rear wall 80-1, and one or more apertures formed proximate to a fourth edge 84d of the rear wall 80-1. The first edge 84a may be opposite (e.g., parallel to) the second edge 84b, and the third edge 84c may be opposite (e.g., parallel to) the fourth edge 84d.

In some implementations, the latch features 82a include a first arm 86 extending in a direction Z2, and a second arm 88 extending from the first arm 86 in a direction Y2 such that the first arm 86 and the second arm 88 define an “L” shape. In this regard, the second arm 88 and the edge 84a may define a void 90 therebetween. The fourth direction Z2 may be opposite the third direction Z, and the fifth direction Y2 may be opposite the second direction Y.

In some implementations, the latch features 82b include a first arm 92 extending in the direction Z2, and a second arm 94 extending from the first arm 92 in the direction Y2 such that the first arm 92 and the second arm 94 define an “L” shape. In this regard, the second arm 94 and the edge 84b may define a void 96 therebetween.

The latch features 82c and the latch features 82d may include one or more apertures. In this regard, the latch features 82c and the latch features 82d may be illustrated and described herein as apertures 82c and apertures 82d.

With reference to FIG. 4C, a second cover 32a is illustrated. As will be explained in more detail below, the second cover 32a may be used in combination with (e.g., assembled to) the first cover 30a, 30b. References to the second cover 32 throughout the disclosure are understood to apply equally to the second cover 32a, unless specifically stated otherwise.

The second cover 32a may include a rear wall 80-1a. In some implementations, the second cover 32a is formed from a stamped metal plate such that the rear wall 80-1a defines a monolithic construct. It will be appreciated, however, that the second cover 32a may be formed from different materials (e.g., a polymer, carbon fiber, etc.) and by different processes (e.g., molding, three-dimensional printing, etc.) within the scope of the present disclosure.

The rear wall 80-1a may include one or more latch features (e.g., recesses 82e) extending inwardly from the third edge 84c of the rear wall 80-1a. The first edge 84a may be opposite (e.g., parallel to) the second edge 84b, and the third edge 84c may be opposite (e.g., parallel to) the fourth edge 84d. The recesses 82e may be defined by a first edge 160, a second edge 162, and a third edge 164 of the rear wall 80-1a. The first edge 160 may be opposite (e.g., parallel to) the second edge 162. The third edge 164 may be transverse (e.g., orthogonal) to one or both of the first edge 160 and the second edge 162. The connection between (i) the first edge 160 and the third edge 164 and (ii) the second edge 162 and the third edge 164 may be stepped or tapered. For example, in some implementations, the recess 82e is defined in part by one or more steps 168 where the first edge 160 connects to the third edge 164 and where the second edge 162 connects to the third edge 164. The steps 168 may form a protrusion (e.g., a square protrusion) extending from one or more of the first, second, and third edges 160, 162, 164.

### Side Cover

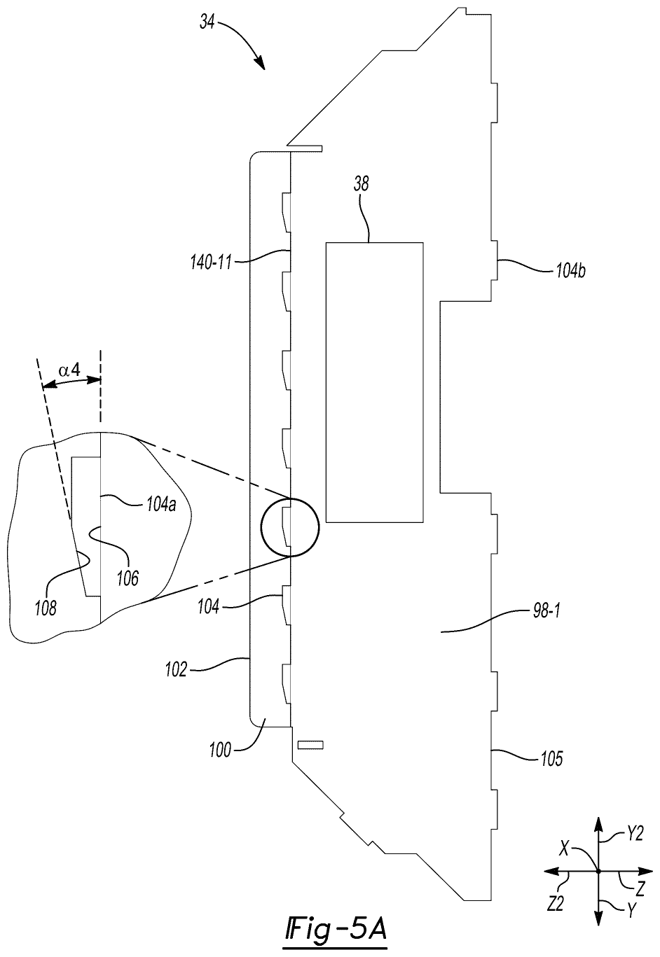

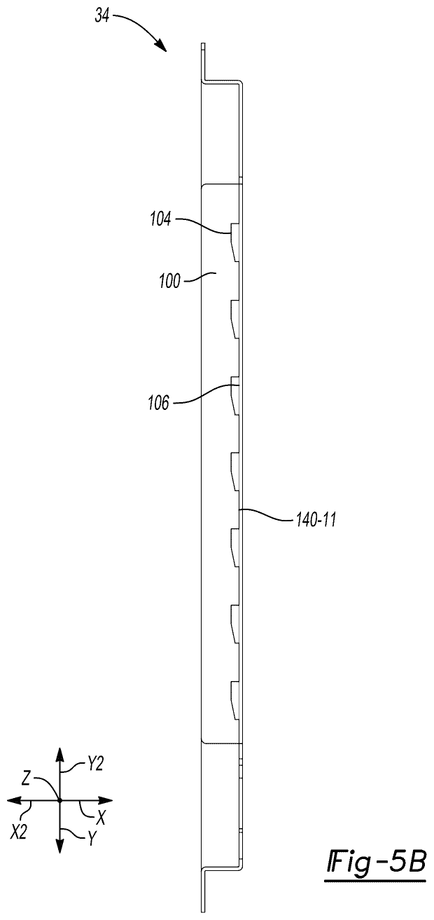

With reference to FIGS. 5A and 5B, the third cover 34 may include one or more walls 98. For example, the third cover 34 may include a side wall 98-1. It will be appreciated that the third cover 34 may include more than one wall 98 within the scope of the present disclosure. In some implementations, the third cover 34 is formed from a stamped metal plate such that the wall(s) 98 define a monolithic construct. It will be appreciated, however, that the third cover 34 may be formed from different materials (e.g., a polymer, carbon fiber, etc.) and by different processes (e.g., molding, three-dimensional printing, etc.) within the scope of the present disclosure.

The side wall 98-1 may include a lip 100 extending therefrom. In some implementations, the side wall 98-1 and the lip 100 extend in transverse (e.g., orthogonal) directions such that the side wall 98-1 and the lip 100 define an “L” shape. In this regard, the lip 100 may extend from the side wall 98-1 in the direction X2. In some implementations, the lip 100 forms at least a portion of an edge 102 of the side wall 98-1.

The side wall 98-1 may include one or more latch features 104. In some implementations, the latch features 104 include one or more apertures 104a disposed proximate the edge 102, and one or more tabs 104b disposed proximate to, and extending from, a second edge 105 that is opposite the edge 102. The apertures 104a may be defined in part by edges 106, 108 defining an angle α4. The a4 may be greater than 0 degrees and less than one ninety degrees. In some implementations, the angle α4 is substantially (e.g., +/−20 degrees) equal to 25 degrees. As will be explained in more detail below, during assembly of the system 10, the angle α may cause the latch feature 104 to form a friction-fit with the latch feature 70a of the first cover 30 to ensure a secure connection between the first and third covers 30, 34. In some implementations, the tabs 104b are substantially similar to the tabs 58.

### Cover Lockdown Subassembly

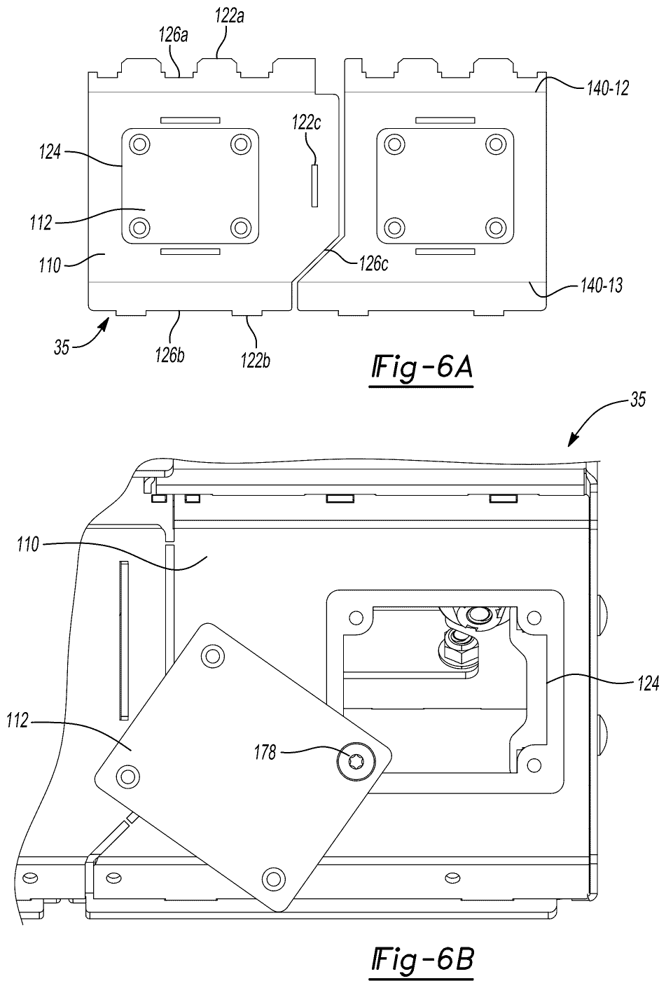

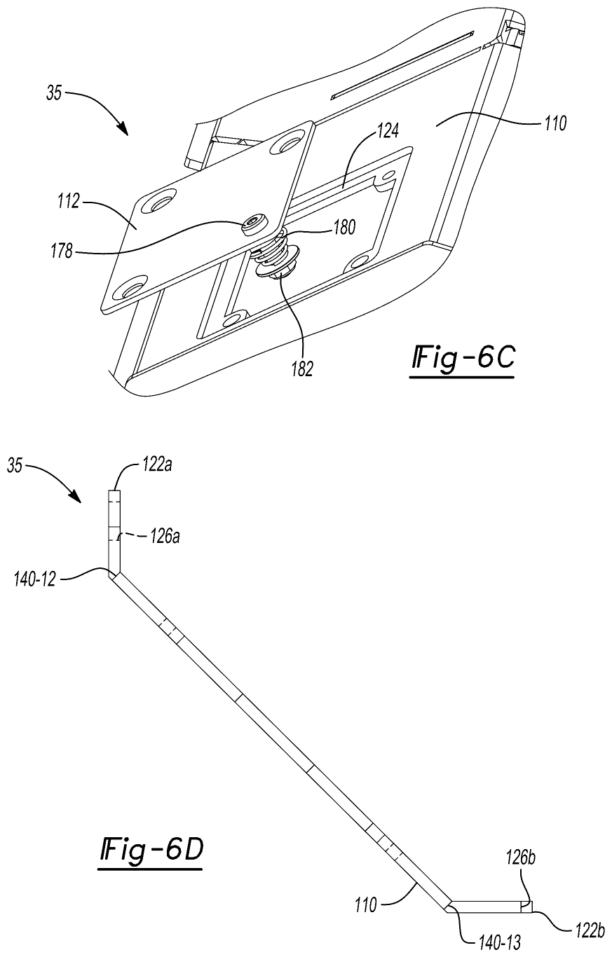

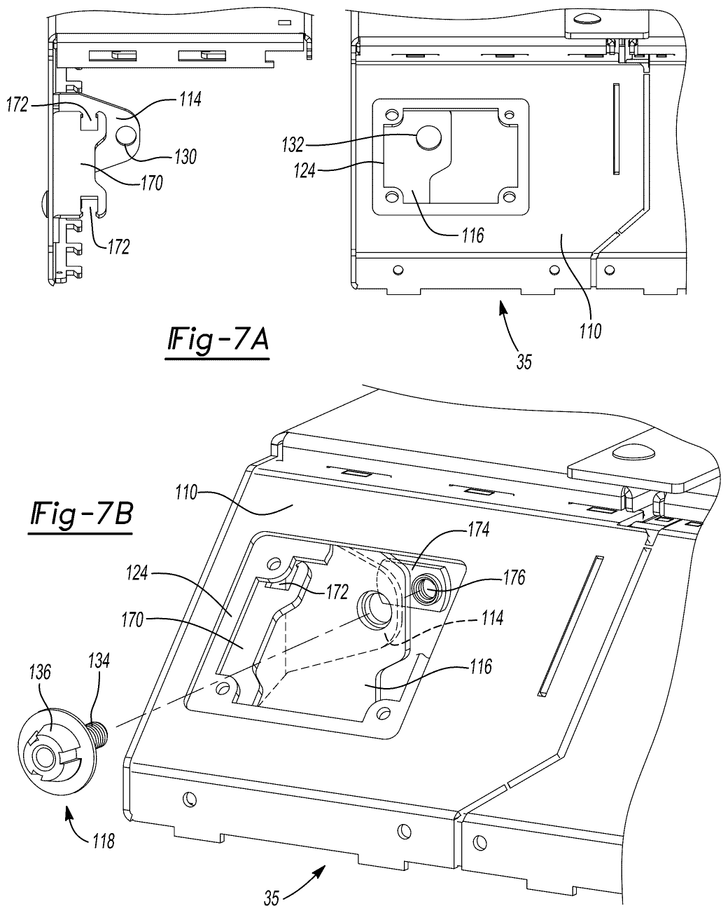

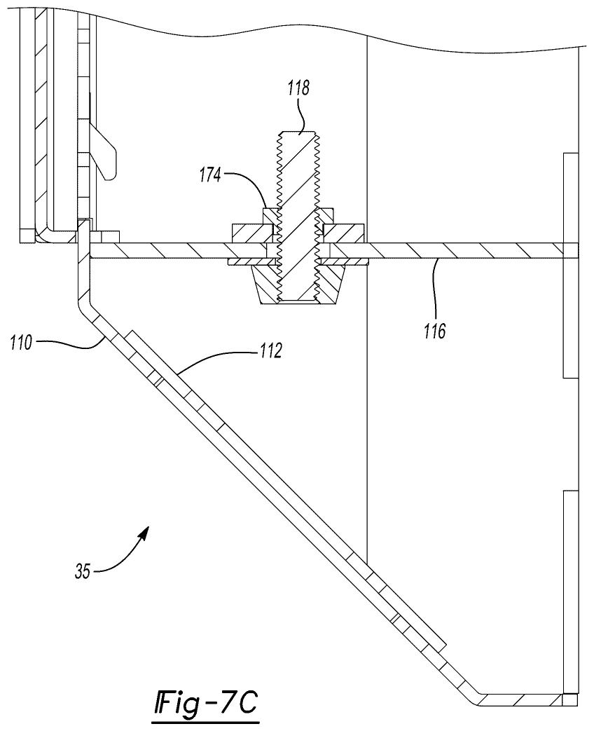

With reference to FIGS. 6A-7C, the cover lockdown subassembly 35 may include a base plate 110, a cover plate 112, a first locking plate 114, a second locking plate 116, and a fastener 118. As will be explained in more detail below, the cover lockdown subassembly 35 may be coupled to one or more of the front cover 30, the rear cover 32, and the side cover 34 to secure the front cover 30, the rear cover 32, and/or the side cover 34 to one or more of the others of the front cover 30, the rear cover 32, and the side cover 34.

As illustrated in FIGS. 6A-6D, the base plate 110 may include one or more latch features 122 and an aperture (e.g., a through-hole) 124. In some implementations, the latch features 122 include one or more tabs 122a extending from a first edge 126a of the base plate 110, one or more tabs 122b extending from a second edge 126b of the base plate 110, and one or more apertures formed proximate to a third edge 126c of the base plate 110. The first edge 126a may be opposite (e.g., parallel to) the second edge 126b, and the third edge 126c may extend between the first edge 126a and the second edge 126b.

The latch features 122a may be substantially similar to the latch features 70c. The latch features 122b may include tabs extending from the second edge 126b, and the latch features 122c may include one or more apertures.

With reference to FIG. 7A, the first locking plate 114 may be secured to the side cover 34 by welding, mechanical fasteners, and/or other suitable means, and may define an aperture 130. The second locking plate 116 may be secured to the rear cover 32 by welding, mechanical fasteners, and/or other suitable means, and may define an aperture 132. As illustrated in FIG. 7B, the fastener 118 may include a bolt or screw having a threaded portion 134 and a head portion 136 integrally formed therewith. In some implementations, an outer peripheral surface of the head portion 136 defines a tapered (e.g., frustoconical) shape.

In the assembled configuration, the fastener 118 (e.g., the threaded portion 134) is coupled to the first locking plate 114 and the second locking plate 116 to secure the side cover 34 to the rear cover 32. For example, the fastener 118 may be disposed within (e.g., threaded into) the apertures 130, 132. As will be explained in more detail below, the tapered shape of the head portion 136 may inhibit a user from engaging and turning and/or removing the fastener 118 from the first and/or second locking plates 114, 116.

In some implementations, the cover lockdown subassembly 35 includes a third locking plate 174, which includes an aperture 176. In the assembled configuration, the fastener 118 (e.g., the threaded portion 134) is coupled to the first locking plate 114, the second locking plate 116, and the third locking plate 174 to secure the side cover 34 to the rear cover 32. For example, the fastener 118 may be disposed within (e.g., threaded into) the apertures 130, 132, 176. The third locking plate 174 may help better secure the side cover 34 to the rear cover 32.

As illustrated in FIGS. 6B and 6C, the cover plate 112 may be secured to the base plate 110 by one or more mechanical fasteners (e.g., bolts, screws, etc.), welding, adhesive, a keyed lock, or other suitable means. For example, the cover plate 112 may be disposed within the aperture 124 and secured to the base plate 110 such that the cover plate 112 inhibits access to the fastener 118. In some implementations, a bolt 178 is inserted through openings in the cover plate 112 and the base plate 110. A spring 180 (e.g., a conical spring) may be placed around the bolt 178 and secured with a nut 182 (e.g., a jamb nut). This allows the cover plate 112 to be rotated to reveal at least a portion of the aperture 124 while preventing the cover plate 112 from being completely removed from the base plate 110.

In some implementations, the cover lockdown subassembly 35 includes a fourth locking plate 170. The fourth locking plate 170 may be secured to the side cover 34 by welding, mechanical fasteners, and/or other suitable means, and may define at least one opening 172. In the assembled configuration, the at least one opening 172 may be disposed behind the base plate 110 (e.g., the aperture 124). In some implementations, the one or more mechanical fasteners (e.g., bolts, screws, etc.) that secure the cover plate 112 to the base plate 110 extend through the at least one opening 172 to secure the side cover 34 to the base plate 110.

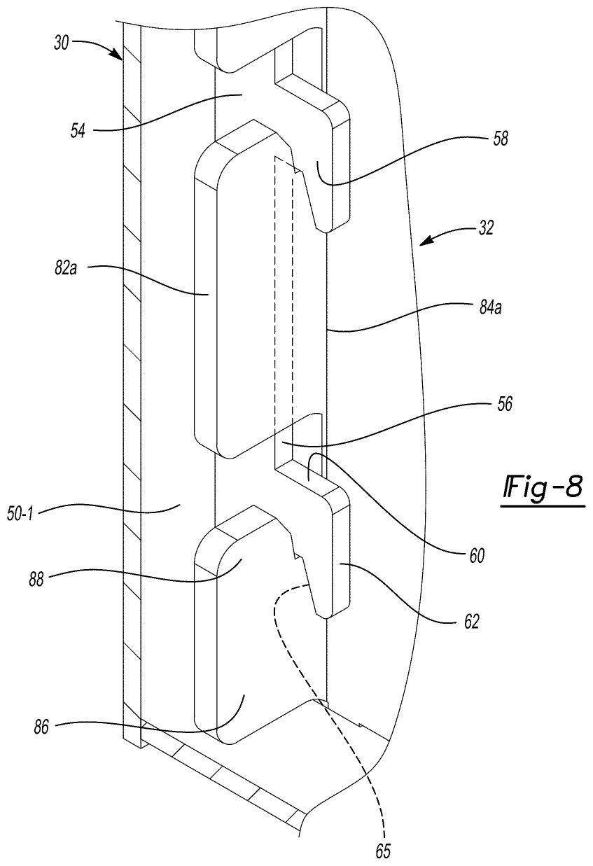

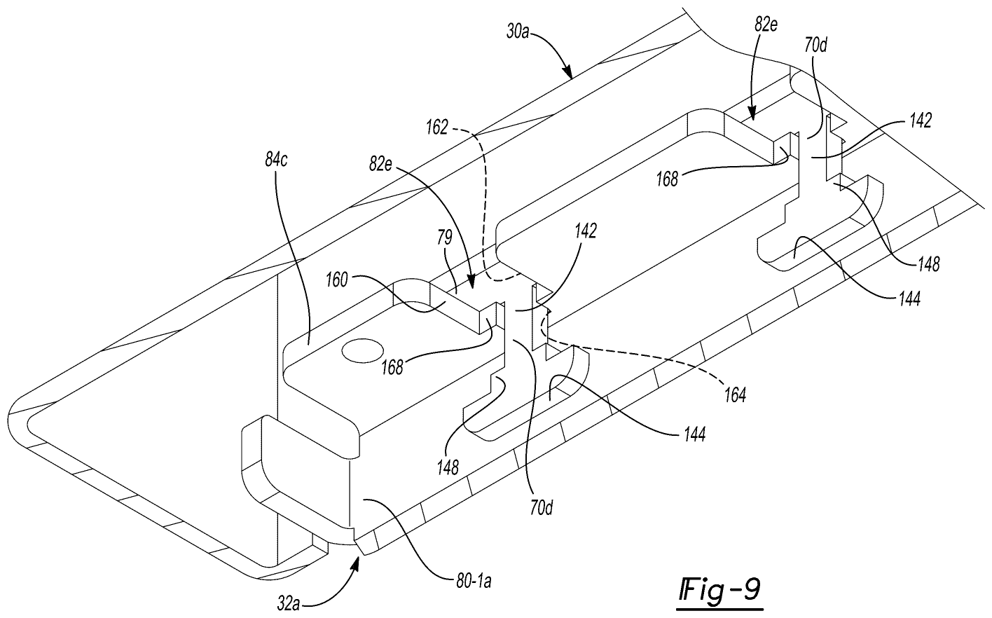

As illustrated in FIGS. 8 and 9, in an assembled configuration, the first cover 30 may be removably coupled to the second cover 32. In the assembled configuration, the latch feature 58 of the first cover 30 mates with the latch feature 82a of the second cover 32 to ensure a secure connection between the first and second covers 30, 32. Also, in the assembled configuration, the latch feature 70d of the first cover 30 mates with the latch feature 82e of the second cover 32 to ensure a secure connection between the first and second covers 30, 32.

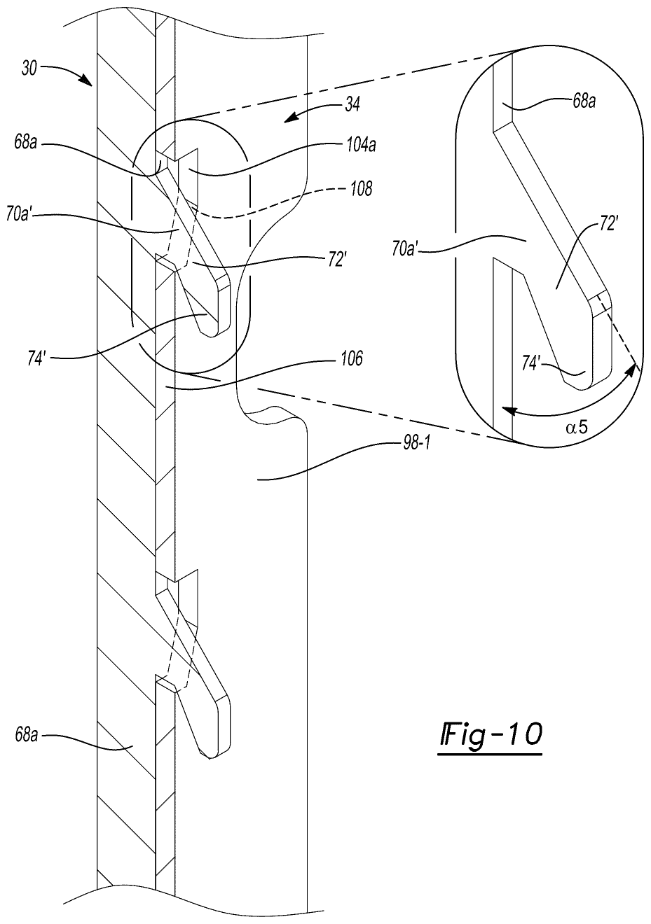

As illustrated in FIG. 10, in some implementations, the first cover 30 includes one or more latch features 70a′. The one or more latch features 70a′ may be substantially similar to the one or more latch features 70a, except as otherwise shown or described herein. In some implementations, the one or more latch features 70a′ include a first arm 72′ extending from the edge 68a in a first direction, and a second arm 74′ extending from the first arm 72′ in a second direction transverse to the first direction. In some implementations, the edge 68a and the first arm 72′ define an angle α5 therebetween. The angle α5 may be greater than 0 degrees and less than 90 degrees. In some implementations, the angle α5 is substantially equal to 45 degrees (+/−5 degrees). As will be explained in more detail below, during assembly of the system 10, the angle α5 may allow the latch feature 70a′ to mate more easily within the aperture 104a of the third cover 34 to ensure a secure connection between the first and third covers 30, 34.

The second housing assembly 22 may include components (e.g., a front cover 30, a rear cover 32, and a side cover 34) having a similar structure and functionality as those (e.g., the front cover 30, the rear cover 32, the side cover 34, and the cover lockdown subassembly 35) described above relative to the first housing assembly 20. In view of the similarity in structure and function of the first housing assembly 20 and the second housing assembly 22, the second housing assembly 22 will not be separately described herein, and the description of the first housing assembly 20 will be understood to apply equally to the second housing assembly 22 except as otherwise noted.

### Assembly Method

A method of assembling a lock system (e.g., lock system 10) will now be described. In a step of assembling the lock system 10, the first cover 30, the second cover 32, the third cover 34, and/or the base plate 110 may be bent along a plurality of fold lines 140-1, 140-2, 140-3, 140-4, 140-5, 140-6, 140-7, 140-8, 140-9, 140-10, 140-11, 140-12, 140-13 from the orientations illustrated in FIGS. 3A, 3C, 3E, 4A, 5A, and 6A to the orientations illustrated in FIGS. 3B, 3D, 3F, 4B, 5B, and 6B, respectively. In another step of assembling the lock system 10, the first cover 30, 30a, 30b, the second cover 32, or the third cover 34 may be removably coupled to one or more of the others of the first cover 30, 30a, 30b, the second cover 32, or the third cover 34 to enclose the interior portion 36 of the first housing assembly 20 and/or the second housing assembly 22. For example, the side wall 50-1 of the first cover 30, 30a, 30b may be removably-coupled to the rear wall 80-1 of the second cover 32, and the front wall 50-2 of the first cover 30, 30a, 30b may be removably-coupled to the side wall 98-1 of the third cover 34. As illustrated in FIG. 8, in some implementations, the latch features 58 are coupled to the latch features 82a, the latch features 70a are coupled to the latch features 104, the latch features 70b are coupled to the latch features 122a, and the latch features 70c are coupled to the latch features 82c.

The method of assembling the lock system 10 may include disposing the tabs 58 within the void 90 and the tabs 70a within the apertures 104a. The edge 65 and the angle α1 may force the edge 56 towards the edge 84a. The edge 78 and the angle α2 may force the edge 68a towards the edge 106. The edges 81, 83 and the angle α3 may cause the tabs 70c to be disposed within the apertures 82c in a friction fit manner.

In other implementations, the latch features 70d, 70e are coupled to the latch features 82e, and the method of assembling the lock system 10 may include disposing the tabs 58 within the void 90 and the tabs 70a within the apertures 104a. The edge 65 and the angle α1 may force the edge 56 towards the edge 84a. The edge 78 and the angle α2 may force the edge 68a towards the edge 106. The shape of the latch features 70d, 70e, and the latch features 82e may initially provide clearance and prevent interference between the first cover 30a, 30b and the second cover 32a as the first cover 30a, 30b is coupled to the second cover 32a. As the first cover 30a, 30b and the second cover 32a reach the final, assembled position, the steps 158 may interact with (e.g., contact) the steps 168. In the final, assembled position the latch features 70d, 70e may be disposed within the void 165. The contact between the steps 158, 168 may prevent the upper wall 50-3a, 50-3b from being separated from the second cover 32 (e.g., by an inmate). For example, the upper wall 50-3a, 50-3b may be separated from the second cover 32a by no more than a quarter of an inch (0.25″)

The method of assembling the lock system 10 may also include disposing the tabs 104b within the voids 96, the tabs 122a within the apertures 70b, and the tabs 122b within the apertures 82d. In particular, the tabs 122a may be disposed within the apertures 70b in a friction fit manner. In the assembled configuration, the lip 54 may engage the rear wall 80-1 such that the first cover 30 forms a seam with the second cover 32, and the first lip 66a (e.g., the edge 68a) may engage the lip 100 such that the first cover 30 forms a seam with the third cover 34.

The method of assembling the lock system 10 may further include assembling the cover lockdown subassembly 35. For example, the method may include disposing the fastener 118 within the aperture 130 and the aperture 132 to further secure the first cover 30 to the second cover 32. In particular, the method may include threading the threaded portion 134 into the first locking plate 114. The method may also include disposing the cover plate 112 within the aperture 124 and/or securing the cover plate 112 to the cover base plate 110.

The configuration of the system 10 described herein may be formed and/or assembled without the use of fasteners (e.g., bolts, screws, rivets, etc.), other than the latch features 58, 70, 82, to secure the first, second, or third covers 30, 30a, 30b, 30c 32, 32a, 32b, 34, 34a to others of the first, second, or third covers 30, 30a, 30b, 30c, 32, 32a, 32b, 34, 34a. In this way, the system 10 can prevent intrusion into the interior portion 36, 36a of the first and second housing assemblies 20, 22, and prevent tampering with the lock mechanism 19 disposed therein. While certain “latch features” are shown and described herein as being “tabs” or “apertures” or “voids,” it will be appreciated that latch features that are shown and described herein as “tabs” may, in the alternative be “apertures” and/or “voids,” and latch features that are shown and described herein as “apertures” and/or “voids” may, in the alternative be “tabs,” such that latch features that are tabs may be coupled to latch features that are apertures and/or voids to secure the covers (e.g., 30, 32, 34) to one another and/or the base plate 110 during assembly of the housing assemblies 20, 22.

The following Clauses provide an exemplary configuration for a lock system and method, as described above.

Clause 1: A lock system comprising: a first cover including a first wall, a second wall, a first latch feature, a second latch feature, a third latch feature, and a fourth latch feature, the first wall extending in a first direction, the second wall coupled to the first wall and extending in a second direction transverse to the first direction, the first latch feature and the second latch feature coupled to the first wall and extending in a third direction transverse to the first direction, and the third latch feature and the fourth latch feature coupled to the second wall and extending in a fourth direction transverse to the second direction; a second cover including a third wall, a fifth latch feature, and a sixth latch feature, the third wall extending in a fifth direction, the fifth latch feature and the sixth latch feature coupled to the third wall and extending in a sixth direction transverse to the fifth direction, the fifth latch feature configured to couple to the first latch feature, the sixth latch feature configured to couple to the second latch feature; and a third cover extending in a seventh direction and includes a seventh latch feature and an eighth latch feature, the seventh latch feature configured to receive the third latch feature, and the eighth latch feature configured to receive the fourth latch feature.

Clause 2: The lock system of clause 1, wherein the fifth latch feature and the third wall define a first void configured to receive the first latch feature.

Clause 3: The lock system of clause 2, wherein the fifth latch feature includes an edge at least partially defining the first void, wherein the edge and the third wall define an angle greater than zero degrees and less than ninety degrees.

Clause 4: The lock system of clause 3, wherein the edge is configured to engage the first latch feature in a friction-fit configuration.

Clause 5: The lock system of any of clauses 1 through 4, wherein the sixth latch feature and the third wall define a second void configured to receive the second latch feature.

Clause 6: The lock system of any of clauses 1 through 5, wherein the first latch feature and the first wall define a third void configured to receive the fifth latch feature.

Clause 7: The lock system of clause 6, wherein the fifth latch feature includes an edge at least partially defining the third void, wherein the edge and the first wall define an angle greater than zero degrees and less than ninety degrees.

Clause 8: The lock system of clause 7, wherein the edge is configured to engage the fifth latch feature in a friction-fit configuration.

Clause 9: The lock system of any of clauses 6 through 8, wherein the first latch feature includes a tab defining an L-shape.

Clause 10: The lock system of clause 9, wherein the fifth latch feature includes a tab defining an L-shape configured to engage the first latch feature.

Clause 11: The lock system of any of clauses 1 through 10, wherein the first cover, the second cover, and the third cover form a housing surrounding a chamber, and wherein the lock system includes a lock mechanism disposed within the chamber.

Clause 12: A method of assembling a lock system including a first cover, a second cover, and a third cover, the first cover including a first wall, a second wall, a first latch feature, a second latch feature, a third latch feature, and a fourth latch feature, the first wall extending in a first direction, the second wall coupled to the first wall and extending in a second direction transverse to the first direction, the first latch feature and the second latch feature coupled to the first wall and extending in a third direction transverse to the first direction, the third latch feature and the fourth latch feature coupled to the second wall and extending in a fourth direction transverse to the second direction, the second cover including a third wall, a fifth latch feature, and a sixth latch feature, the third wall extending in a fifth direction, the fifth latch feature and the sixth latch feature coupled to the third wall and extending in a sixth direction transverse to the fifth direction, the fifth latch feature configured to receive the first latch feature, the third cover extending in a seventh direction and seventh latch feature and an eighth latch feature, the method comprising: coupling the first latch feature with the fifth latch feature; coupling the second latch feature with the sixth latch feature; coupling the third latch feature with the seventh latch feature; and coupling the fourth latch feature with the eighth latch feature.

Clause 13: The method of clause 12, wherein the fifth latch feature and the third wall define a first void, and wherein coupling the first latch feature to the fifth latch feature includes disposing the first latch feature in the first void.

Clause 14: The method of clause 13, wherein the sixth latch feature and the third wall define a second void, and wherein coupling the second latch feature with the sixth latch feature includes disposing the second latch feature in the second void.

Clause 15: The method of any of clauses 13 through 14, wherein the seventh latch feature defines a first aperture, and the eighth latch feature defines a second aperture, the method further comprising: moving the first latch feature in the third direction within the first void; moving the second latch feature in the third direction within the first void; moving the fifth latch feature in the sixth direction within the first aperture; and moving the sixth latch feature in the sixth direction within the second aperture.

Clause 16: The method of clause 15, further comprising: moving the first latch feature in a seventh direction transverse to the third direction within the first void; moving the second latch feature in the seventh direction within the first void; moving the fifth latch feature in the seventh direction within the first aperture; and moving the sixth latch feature in the seventh direction within the second aperture.

Clause 17: The method of any of clauses 15 through 16, further comprising engaging the first latch feature with the third wall and the third latch feature.

Clause 18: The method of clause 17, wherein the first cover includes a first lip extending from the first wall in the third direction, and wherein the first latch feature extends from the first lip in the third direction, the method further comprising engaging the first lip with the second cover.

Clause 19: The method of clause 18, further comprising engaging the fifth latch feature with the third cover in a friction-fit configuration.

Clause 20: The method of any of clauses 18 through 19, wherein the first cover includes a first lip extending from the second wall in the fourth direction, and wherein the third latch feature extends from the first lip in the fourth direction, the method further comprising engaging the first lip with the third cover.

Clause 21: A lock system comprising: a first cover including a first wall extending in a first direction, a second wall coupled to the first wall and extending in a second direction transverse to the first direction, a first latch feature, and a second latch feature; a second cover extending in a third direction and including a third latch feature configured to receive the first latch feature; and a third cover extending in a fourth direction and including a fourth latch feature configured to receive the second latch feature.

Clause 22: The lock system of clause 21, wherein: the first wall includes the first latch feature, and the second wall includes the second latch feature.

Clause 23: The lock system of any of clauses 21 through 22, wherein: the first cover includes a third wall coupled to the first wall and extending in a fifth direction transverse to the first direction and the second direction, the third wall including a fifth latch feature; and the second cover includes a sixth latch feature configured to receive the fifth latch feature.

Clause 24: The lock system of clause 23, wherein the fifth latch feature includes a tab defining a T-shape.

Clause 25: The lock system of clause 24, wherein: the fifth latch feature includes a first protrusion, the sixth latch feature includes a second protrusion, and the first protrusion is configured to engage the second protrusion.

Clause 26: The lock system of clause 23, wherein the fifth latch feature includes, a first arm, a second arm parallel to the first arm, and a third arm connected and transverse to the first arm, and the second arm.

Clause 27: The lock system of any of clauses 21 through 26, wherein the third latch feature and a fourth wall of the second cover define a first void configured to receive the first latch feature.

Clause 28: The lock system of clause 27, wherein the third latch feature includes an edge at least partially defining the first void, wherein the edge and the fourth wall define an angle greater than zero degrees and less than ninety degrees.

Clause 29: The lock system of clause 28, wherein the edge is configured to engage the first latch feature in a friction-fit configuration.

Clause 30: The lock system of any of clauses 21 through 29, wherein the fourth latch feature and a fifth wall of the third cover define a second void configured to receive the second latch feature.

Clause 31: The lock system of any of clauses 21 through 30, wherein the first latch feature and the first wall define a third void configured to receive the third latch feature.

Clause 32: The lock system of clause 31, wherein the first latch feature includes an edge at least partially defining the third void, wherein the edge and the first wall define an angle greater than zero degrees and less than ninety degrees.

Clause 33: The lock system of clause 32, wherein the edge is configured to engage the third latch feature in a friction-fit configuration.

Clause 34: The lock system of clause 31, wherein the first latch feature includes a tab defining an L-shape.

Clause 35: The lock system of clause 34, wherein the third latch feature includes a tab defining an L-shape configured to engage the first latch feature.

Clause 36: The lock system of any of clauses 21 through 35, wherein the first cover, the second cover, and the third cover form a housing surrounding a chamber, and wherein the lock system includes a lock mechanism disposed within the chamber.

Clause 37: A latching mechanism comprising: a first arm extending in a first direction; and a second arm extending from the first arm in a second direction transverse to the first direction, wherein the first arm is connected to a point proximate a center of the second arm.

Clause 38: The latching mechanism of clause 37, wherein the first direction is orthogonal to the second direction.

Clause 39: The latching mechanism any of clauses 37 through 38, further including a first protrusion extending from a first connection point of the first arm and the second arm.

Clause 40: The latching mechanism of clause 39, further including a second protrusion extending from a second connection point of the first arm and the second arm.

Clause 41: A latching mechanism comprising: a first arm extending in a first direction; a second arm spaced apart from the first arm and extending in the first direction; and a third arm extending in a second direction transverse to the first direction and connected to the first arm and the second arm.

Clause 42: The latching mechanism of clause 41, wherein the first direction is orthogonal to the second direction.

Clause 43: The latching mechanism any of clauses 41 through 42, further including a first protrusion extending from a first connection point of the first arm and the third arm.

Clause 44: The latching mechanism of clause 43, further including a second protrusion extending from a second connection point of the first arm and the third arm.

Clause 45: The latching mechanism of clause 44, further including a third protrusion extending from a first connection point of the second arm and the third arm.

Clause 46: The latching mechanism of clause 45, further including a fourth protrusion extending from a second connection point of the second arm and the third arm.

Clause 47: A lock system comprising: a first cover including a first wall extending in a first direction and a first latch feature, the first latch feature including a first arm extending from the first wall in a second direction transverse to the first direction and a second arm extending from an end of the first arm in a third direction transverse to the second direction; and a second cover including a second wall extending in a fourth direction and including a second latch feature configured to receive the first latch feature.

Clause 48: The lock system of clause 47, wherein the first direction is orthogonal to the second direction.

Clause 49: The lock system of any of clauses 47 through 48, wherein the second arm and the first wall define an angle greater than zero degrees and less than ninety degrees.

Clause 50: The lock system of any of clauses 47 through 49, wherein the second latch feature and the second wall of the second cover define a first void configured to receive the first latch feature.

Clause 51: The lock system of clause 50, wherein the second latch feature includes an edge at least partially defining the first void, wherein the edge and the second wall define an angle greater than zero degrees and less than ninety degrees, and wherein the edge is configured to engage the first latch feature in a friction-fit configuration.

Clause 52: A lock system comprising: a first cover including a first wall extending in a first direction and a first latch feature, the first latch feature including a first arm extending from the first wall in a second direction transverse to the first direction and a second arm including a first end and a second end opposite the first end, the second arm extending from the first arm in a third direction transverse to the second direction, the first arm connects to the second arm at a point between the first end and the second end; and a second cover including a second wall extending in a fourth direction and including a second latch feature configured to receive the first latch feature.

Clause 53: The lock system of claim 52, wherein the first arm connects to the second arm at a center point of the second arm.

Clause 54: The lock system of any of clauses 52 through 53, wherein the first direction is orthogonal to the second direction and the third direction is parallel to the first direction.

Clause 55: The lock system of any of clauses 52 through 54, wherein the first latch feature includes a first protrusion extending from a first connection point of the first arm and the second arm.

Clause 56: The lock system of any of clauses 52 through 55, wherein the second latch feature is a recess formed in the second wall.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A lock system comprising:
a first cover including a first wall extending in a first direction, a second wall coupled to the first wall and extending in a second direction transverse to the first direction, a first latch feature, and a second latch feature;
a second cover extending in a third direction and including a third latch feature configured to receive the first latch feature; and
a third cover extending in a fourth direction and including a fourth latch feature configured to receive the second latch feature.

2. The lock system of claim 1, wherein:
the first wall includes the first latch feature, and
the second wall includes the second latch feature.

3. The lock system of claim 1, wherein:
the first cover includes a third wall coupled to the first wall and extending in a fifth direction transverse to the first direction and the second direction, the third wall including a fifth latch feature; and
the second cover includes a sixth latch feature configured to receive the fifth latch feature.

4. The lock system of claim 3, wherein the fifth latch feature includes a tab defining a T-shape.

5. The lock system of claim 1, wherein the third latch feature and a fourth wall of the second cover define a first void configured to receive the first latch feature.

6. The lock system of claim 5, wherein the third latch feature includes an edge at least partially defining the first void, wherein the edge and the fourth wall define an angle greater than zero degrees and less than ninety degrees.

7. The lock system of claim 1, wherein the first latch feature and the first wall define a third void configured to receive the third latch feature.

8. The lock system of claim 7, wherein the first latch feature includes an edge at least partially defining the third void, wherein the edge and the first wall define an angle greater than zero degrees and less than ninety degrees.

9. The lock system of claim 8, wherein the edge is configured to engage the third latch feature in a friction-fit configuration.

10. The lock system of claim 1, wherein the first cover, the second cover, and the third cover form a housing surrounding a chamber, and wherein the lock system includes a lock mechanism disposed within the chamber.

11. A lock system comprising:
a first cover including a first wall extending in a first direction and a first latch feature, the first latch feature including a first arm extending from the first wall in a second direction transverse to the first direction and a second arm extending from an end of the first arm in a third direction transverse to the second direction; and
a second cover including a second wall extending in a fourth direction and including a second latch feature configured to receive the first latch feature.

12. The lock system of claim 11, wherein the first direction is orthogonal to the second direction.

13. The lock system of claim 12, wherein the second arm and the first wall define an angle greater than zero degrees and less than ninety degrees.

14. The lock system of claim 11, wherein the second latch feature and the second wall of the second cover define a first void configured to receive the first latch feature.

15. The lock system of claim 14, wherein the second latch feature includes an edge at least partially defining the first void, wherein the edge and the second wall define an angle greater than zero degrees and less than ninety degrees, and wherein the edge is configured to engage the first latch feature in a friction-fit configuration.

16. A lock system comprising:
a first cover including a first wall extending in a first direction and a first latch feature, the first latch feature including a first arm extending from the first wall in a second direction transverse to the first direction and a second arm including a first end and a second end opposite the first end, the second arm extending from the first arm in a third direction transverse to the second direction, the first arm connects to the second arm at a point between the first end and the second end; and
a second cover including a second wall extending in a fourth direction and including a second latch feature configured to receive the first latch feature.

17. The lock system of claim 16, wherein the first arm connects to the second arm at a center point of the second arm.

18. The lock system of claim 16, wherein the first direction is orthogonal to the second direction and the third direction is parallel to the first direction.

19. The lock system of claim 16, wherein the first latch feature includes a first protrusion extending from a first connection point of the first arm and the second arm.

20. The lock system of claim 16, wherein the second latch feature is a recess formed in the second wall.
